(19) United States
(12) Patent Application Publication
(10) Pub. No.: US 2017/0195026 A1
(43) Pub. Date: Jul. 6, 2017

(54) SINGLE USER BEAMFORMING IN WIRELESS NETWORKS

(71) Applicant: INTEL IP CORPORATION, SANTA CLARA, CA (US)

(72) Inventors: Chittabrata Ghosh, Fremont, CA (US); Ilan Sutskover, Hadera (IL)

(21) Appl. No.: 15/200,952

(22) Filed: Jul. 1, 2016

Related U.S. Application Data
(60) Provisional application No. 62/275,176, filed on Jan. 5, 2016.

(51) Int. Cl. H04B 7/06; H04B 7/04

(52) U.S. Cl. CPC H04B 7/0617; H04B 7/0452; H04W 84/12

(57) ABSTRACT

A device is disclosed comprising: at least one memory that stores computer-executable instructions; and at least one processor of the one or more processors configured to access the at least one memory, wherein the at least one processor of the one or more processors is configured to execute the computer-executable instructions to: cause to send an announcement frame to at least one first device, wherein the announcement frame indicates the device capable of beamforming a single user (SU) device; cause to send a trigger frame to the at least one first device; determine a first report frame received from the at least one first device, wherein the report frame includes a first indication the at least one first device is a first SU device; and determine, based at least in part on the first report frame, to perform SU beamforming with the at least one first device.

### CROSS REFERENCE TO RELATED APPLICATION

This application claims the benefit of U.S. Patent Application No. 62/275,176, the disclosure of which is incorporated herein by reference as set forth in full.

### TECHNICAL FIELD

This disclosure generally relates to systems and methods for wireless communications and, more particularly, single user (SU) beamforming in wireless networks, such as wireless local area networks (WLANs).

### BACKGROUND

Wireless devices are becoming widely prevalent and are increasingly requesting access to wireless channels. A next generation WLAN, IEEE 802.11ax or High-Efficiency WLAN (HEW), is under development. HEW utilizes Orthogonal Frequency-Division Multiple Access (OFDMA) in channel allocation. Additionally, this and similar standards can include beamforming (BF) schemes including single-user BF (SU-BF) and multiuser BF (MU-BF) methods to improve spectral efficiency with a given channel condition.

### BRIEF DESCRIPTION OF THE DRAWINGS

Reference will now be made to the accompanying drawings, which are not necessarily drawn to scale, and wherein:

FIG. 1 is an illustrative sequence diagram of frame exchanges between for very high throughput (VHT) beamforming devices, in accordance with example embodiments of the disclosure.

FIG. 2 is an illustrative sequence diagram of frame exchanges between high efficiency (HE) beamforming devices, in accordance with example embodiments of the disclosure.

FIG. 3 is an illustrative null data packet (NDP) announcement frame, in accordance with example embodiments of the disclosure.

FIG. 4 is an illustrative frame format of a high-efficiency (HE) control field within a compressed beamforming feedback report (CBFR) sent by a beamformee, in accordance with example embodiments of the disclosure.

FIG. 5A is an illustrative flow diagram of a sounding protocol, in accordance with example embodiments of the disclosure.

FIG. 5B is an illustrative flow diagram of a sounding protocol, in accordance with example embodiments of the disclosure.

FIG. 6 is an illustrative radio unit, in accordance with example embodiments of the disclosure.

FIG. 7 is an illustrative computational environment, in accordance with example embodiments of the disclosure.

### DETAILED DESCRIPTION

Example embodiments described herein provide certain systems, methods, and devices, for providing signaling information to Wi-Fi devices in various Wi-Fi networks, including, but not limited to, IEEE 802.1 lax (referred to as HE or HEW).

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

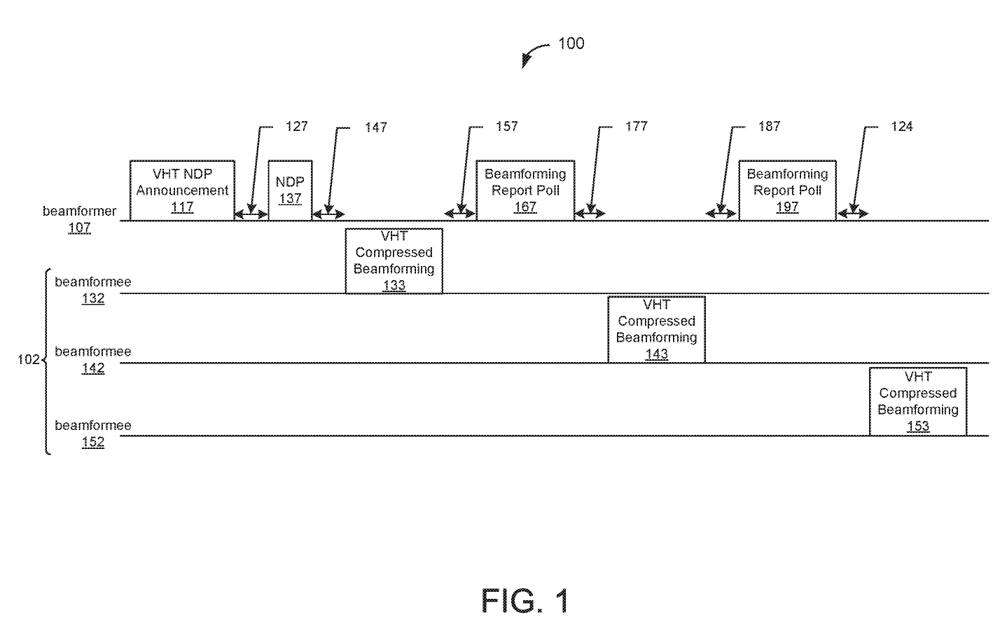

In conventional IEEE 802.11 protocols for downlink multiple input multiple output (DL MU MIMO), the Access Point (AP) typically collects beamforming feedback from one or more stations (STAs) using a pre-defined sequence of frame exchanges. With reference to FIG. 1, an exemplary sequence of frame exchanges is shown. Here, a station (STA) may initiate a channel sounding feedback sequence by transmitting an Null Data Packet (NDP) announcement frame (e.g., Very High Throughput Null Data Packet (VHT NDP) Announcement 117). In some embodiments, the NDP announcement frame may be High Efficiency (HE) NDP Announcement. In some embodiments, the STA initiating the channel sounding feedback sequence may be an AP and may be referred to as a beamformer (e.g., the beamformer 107). One or more responding STAs may transmit beamforming feedback reports in response to receiving a sounding request (e.g., a NDP Announcement) from the AP. The one or more responding STAs may be referred to as the beamformees (e.g., the beamformees 102). The beamformees 102 may be wireless devices such as a laptop, mobile phone, desktop device, or any other mobile device attempting to perform beamforming with the beamformer 107.

In the exemplary frame exchange in FIG. 1, the beamformer 107 may initiate the exchange by transmitting a NDP announcement frame (e.g., the VHT NDP Announcement 117) first followed by a NDP frame (e.g., the NDP frame 137). The NDP frame 137 may be VHT NDP frame or a HE NDP frame. The beamformer 107 may determine which frame to use based on a classification of the beamformees 102. For example, if the beamformees 107 are classified as HE devices then the beamformer 107 may transmit a HE NDP frame. Similarly, if the beamformees 107 are classified as VHT devices then the beamformer 107 may transmit a VHT NDP frame. In some embodiments, one or more of the beamformees 102 may be VHT devices and one or more of the beamformees 102 may be HE devices. Accordingly, the beamformer 107 may send VHT NDP frames to the beamformees 102 that are VHT devices and may send HE NDP frames to the beamformees 102 that are HE devices. The beamformer 107 may accomplish this by transmitting individual NDP announcement frames and NDP frames to each of the respective groups or individual beamformees 102. For example, the beamformee 142 may be a VHT device and the beamformee 152 may be a HE device, thus the beamformer 107 may transmit a VHT NDP announcement frame followed by a VHT NDP frame to the beamformee 142 and transmit a HE NDP announcement frame followed by a HE NDP frame to the beamformee 152. The beamformee 107 may determine to transmit the NDP announcement frames together and the NDP frames together, or in any other order.

There may be a short interframe space (SIFS) 127 between the VHT NDP Announcement 117 and NDP 137. The SIFS may correspond to the amount of time (e.g., in units of microseconds) between when a wireless interface (e.g., transceiver) in the beamformeer 107 or the beamformees 102 receives a first frame from the beamformees 102 or beamformer 107, respectively, and transmits a second frame to the beamformees 102 or beamformer 107 in response to receiving the first frame. The SIFS may be determined by a processor in the beamformees 102 or beamformers 107, which may comprise calculating a difference between when a last symbol corresponding to the second frame is transmitted off an antenna coupled to the transmitter and when a first symbol in the first frame is received on the antenna. The difference may be a positive real number with a resolution that commensurate with a floating point value used by the processor to perform one or more arithmetic operations.

Returning to FIG. 1, after the beamformer 107 transmits the VHT NDP Announcement 117 the beamformer 107 may not transmit or receive a frame during the SIFS 127. The beamformer 107 may then transmit the NDP 137, and then may not transmit or receive a frame during the SIFS 147. It should be noted that the first beamformee to receive the NDP 137 may determine that the beamformer 107 is soliciting a beamforming feedback report, and may transmit a compressed beamforming feedback report to the beamformer 107. For example, the beamformee 132 may receive the NDP 137 first and may generate and transmit a VHT Compressed Beamforming frame 133 to the beamformer 107. After the SIFS 147 the beamformer 107 may receive the beamforming feedback report from the beamformee that received the NDP 137 (e.g., the VHT Compressed Beamforming frame 133) first. After the first beamformee, in this example the beamformee 132, responds to the NDP 137 by transmitting the beamforming feedback report, in this example the VHT Compressed Beamforming frame 133, the beamformer 107 may not transmit or receive a frame while it receives the VHT Compressed Beamforming frame 133, and may wait the SIFS 157 after receiving the VHT Compressed Beamforming frame 133. The beamformer 107 may then transmit a beamforming report poll (e.g., the Beamforming Report Poll 167), which may server the same function as the NDP 137, that is, to solicit a beamforming feedback report from the beamformees that the beamformer 107 did not receive beamforming feedback reports from (e.g., the beamformee 142 and the beamformee 152). After the beamformer 107 transmits the Beamforming Report Poll 167, the beamformee 142 may receive the Beamforming Report Poll 167 and wait the SIFS 177 before transmitting a VHT Compressed Beamforming frame 143. The beamformer 107 may wait the SIFS 187 while receiving the VHT Compressed Beamforming frame 143, and then may transmit another beamforming report poll to any remaining beamformees that it has not received a beamforming feedback report from. In this example, the beamformer 107 may transmit a Beamforming Report Poll 197 to the beamformees 102, which is received by the beamformee 152. The beamformee 152 then may wait the SIFS 124 while receiving the Beamforming Report Poll 197. The beamformee 152 may then transmit a beamforming feedback report (e.g., a VHT Compressed Beamforming frame 153).

The beamforming feedback reports (e.g., the VHT Compressed Beamforming 133, the VHT Compressed Beamforming 143, or the VHT Compressed Beamforming 153) may include information about a channel between the beamformer 107 and the respective beamformees 102 (e.g., the beamformees 132, 142, and 152, respectively). For example, the information about the channel may include information about the width of the channel. For instance, the width of the channel may be measured in hertz corresponding to the amount of bandwidth in frequency occupied by the width of a channel. The width of the channel may also be measured in bits also representing the bandwidth that may be supported by the channel. In some embodiments, wider channels may require larger beamforming matrices because there may be more subcarriers (e.g., subcarrier frequencies) that must be measured by the beamformee. Accordingly, if a first beamformee is using a first channel with a greater width than a second beamformee using a second channel, the first beamformee may have to measure more subcarriers, each of which may correspond to a sub-band within the total bandwidth occupying the channel. As a result the first beamformee may generate a larger beamforming matrix than a beamforming matrix generated by the second beamformee.

The beamforming feedback reports may also include information about beamforming matrices corresponding to a number of spatial streams used to transmit and receive data between each of the beamformees 102 and the beamformer 107. For example, the beamformee 142 may transmit and/or receive data from the beamformer 107 over eight spatial streams, and may determine beamforming matrices for each of one or more channels used to transmit and receive data with each of the eight spatial streams. In some instances the entries in the beamforming matrices, corresponding to a channel of two or more spatial streams may be the same, or approximately the same based on one or more statistical values (e.g., a p-value or calculated probability value), and therefore may be grouped together and a value may be included in a field of the beamforming feedback report indicating that two or more spatial streams have the same, or similar, beamforming matrices.

The beamforming matrices may be used by the beamformer 107 to determine which antenna on the beamformer 107 to transmit frames on to maximize throughput and minimize interference between the antenna on the beamformer 107 and an antenna on a beamformee (e.g., the beamformee 132, beamformee 142, and/or beamformee 152).

The beamformees may determine the beamforming matrices by processing each OFDM symbols received in a NDP frame (e.g., the NDP 137). Each of the beamforming matrices may correspond to an OFDM symbol, and the beamforming matrix corresponding to the OFDM symbol may describe the performance of each subcarrier associated with the OFDM symbol between each transmitter antenna element and each receiver antenna element attached to the beamformer 107 and a beamformee (e.g., the beamformee 132 beamformee 142, or beamformee 152, respectively). The entries in the matrix may comprise information about the received power levels and phase shifts between each transmitter antenna element and each receiver antenna element.

The beamforming matrices may be transformed by a matrix multiplication operation that may result in a Givens rotation of one or more entries in the beamforming matrices. The Givens rotation may be based on angles that may be determined by a beamformer or beamformee in order for the beamformer to determine the transmission power on a plurality of beamformer antenna. The transmission power on each of the plurality of beamformer antenna may be different, resulting in a signal that is directed to one or more antenna on the beamformee with the greatest received signal strength. The beamformee may calculate the angles based on the matrix rotation because of the Givens rotation is based on the angels. The beamforemee may transmit the angles in the beamforming matrix in a particular order, so that the beamformer can delimit each angle. After the beamformee calculates the angels, the beamformee may compress the entries in the beamforming matrix, and may return the compressed beamforming matrix in a compressed beamforming feedback report. The compressed beamforming matrix may summarize the radio link quality/performance for all of the OFDM subcarriers. Upon receipt of the compressed beamforming matrix, the beamformer may determine a steering matrix that may be used to steer data transmitted to the beamformee to the correct transmit antenna on the beamformer so that the radio link with the optimal quality/performance is used to transmit the data.

In conventional IEEE 802.11 protocols for single user (SU) beamforming, the beamformee can send a VHT compressed beamforming feedback report in a SIFS interval when solicited by a NDP frame. The beamformee can be identified by a STA association ID (AID) sub-field within a STA information field of the VHT NDP announcement frame. Prior to the exchange illustrated in FIG. 1 the beamformer 107 may generate at least 12 bit AIDs that may be assigned to each of the beamformees 102. The sub-field within the STA information field may only comprise the least significant 12 bits of the beamformee's AID. The compressed beamforming feedback report can contain a VHT MIMO control field that may include information about the channel width and grouping information about the channel, as mentioned above, selected by the beamformee. For SU beamforming, a feedback type sub-field may be set to “0” to indicate that only a single beamformee is associated with the beamformee.

In conventional MU IEEE 802.11 protocols, a trigger frame-based downlink (DL) sounding sequence as illustrated in FIG. 1, where the NDP frames trigger (solicit) a beamforming feedback report, there can high overhead resulting, for example, from a trigger frame duration on the order of 100 us. The overhead may be reasonable for MU beamforming because there may be several beamformees, and therefore, more time may be necessary to reach the beamformees if the beamformees are dispersed over a large area at varying distances from the beamformer. For example, there may be 100 beamformees associated with a beamformer, wherein a first beamformee may be at the greatest distance at which a signal (e.g., a NDP frame or beamforming report poll frame) may be successfully received and a second beamformee may be at a distance that is closest to the beamformer. Accordingly, the amount of time taken for the NDP frame or beamforming report poll frame to reach the first beamformee will be greater than the amount of time taken for the NDP frame or beamforming report poll frame to reach the second beamformee. As a result, the trigger frame duration must be longer to reach the beamformees that are further away. However, for single user (SU), the overhead (e.g. the trigger frame duration) may not be justified. The methods and systems disclosed herein describe a SU protocol that reduces the overhead that may be experienced by a SU when the SU is reporting its beamforming matrix/matrices.

Disclosed herein are various embodiments directed to reducing this overhead. In one aspect, the VHT beamforming flow can be extended in order to redefine the beamforming flow for an IEEE 802.11ax SU, as described. In various embodiments, the following features for SU beamforming are described. First, an NDP type (either high efficiency (HE) NDP or VHT NDP) sent by the beamformer in an SIFS of the NDP-A frame is disclosed. Second, the beamforming flow between the beamformer and the beamformee similar to the existing IEEE 802.1 lac beamforming flow is disclosed. Third, a protocol is defined for the format of the response frames solicited by the NDP frames. Fourth, a HE MIMO control field is disclosed herein that may be included in feedback reports from a SU beamformee maintaining the format similar to the VHT MIMO control field.

In one embodiment, an IEEE 802.11 lac beamforming sequence may be extended to define the beamforming sequence for HE SU. An advantage of the IEEE 802.1 lac beamforming sequence may be that the sequence allows the beamformee to select the channel width and the grouping information based on, for example, a clear channel assessment (CCA) status and link adaptation information determined by the beamformee or beamformer using the IEEE 802.1 lac protocol. This functionality can be preserved for HE beamformees.

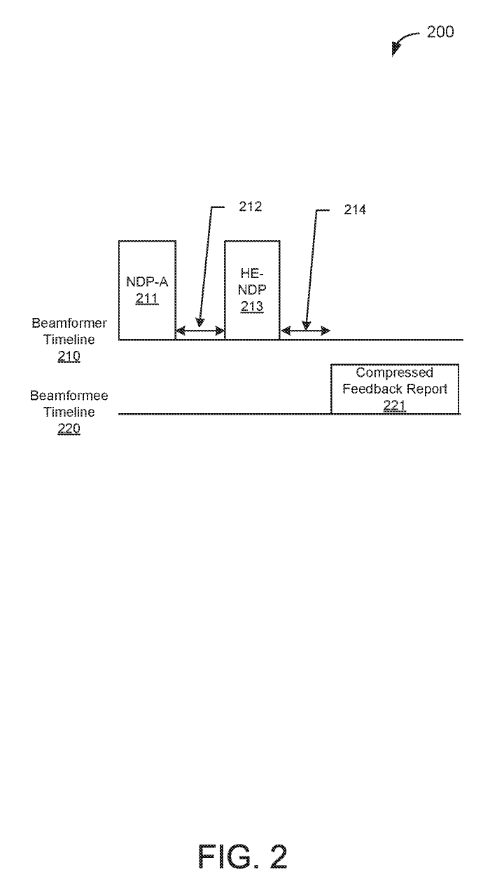

FIG. 2 is an illustrative sequence diagram of frame exchanges 200 between high efficiency (HE) beamforming devices, in accordance with example embodiments of the disclosure. With reference to FIG. 2, in an embodiment, a new SU beamforming protocol can be defined. The SU beamforming protocol can be similar to the IEEE 802.1 lac beamforming sequence. The IEEE 801.1 lac NDP-A frame 211 can be used to initiate SU beamforming. The NDP frame can follow the NDP-A frame 211, e.g. in an SIFS 212. In some embodiments, the NDP frame may be a HE-NDP (e.g., HE NDP 213). In other embodiments, the NDP frame may be a VHT NDP. An indication for the NDP type (e.g., HE-NDP or VHT-NDP) can be signaled in the NDP-A 211 sounding. In some embodiments, it can be a single phase for SU. If the NDP is a HE-NDP, then the compressed beamforming feedback report 221 sent by the beamformee 220 to the beamformer 210 can have the same format as the DL MU sounding feedback report (DL MU SFR). The DL MU SFR may comprise steering matrices for MU-MIMO and signal to noise ratio (SNR) data for OFDM and/or OFDMA. If the NDP is VHT type, then the compressed feedback report 221 can be in same format as for the IEEE 801.11ac beamforming feedback report described above with reference to FIG. 1.

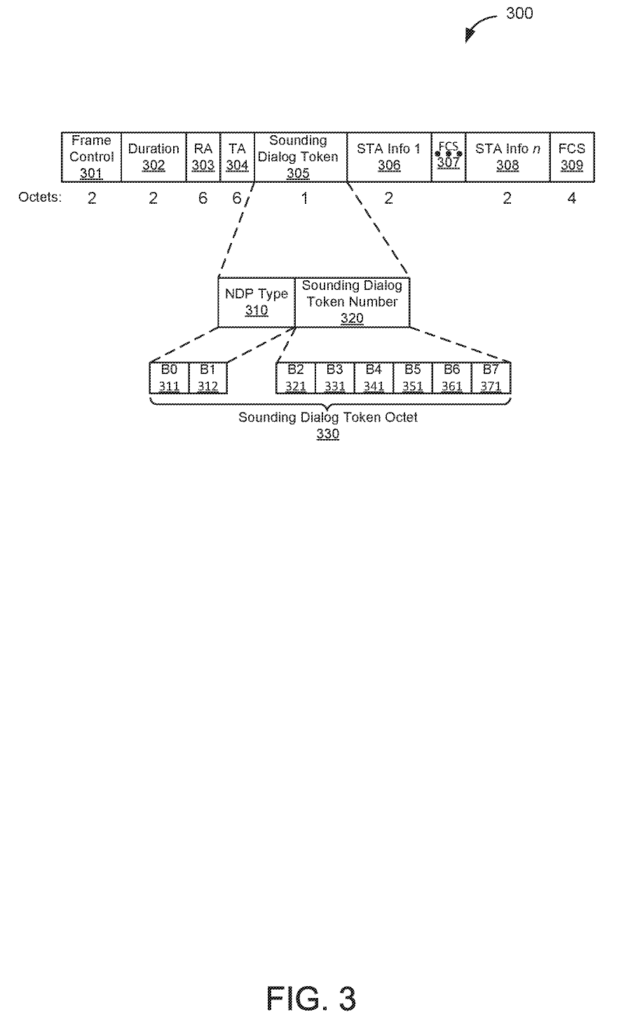

FIG. 3 is an illustrative null data packet (NDP) announcement frame 300, in accordance with example embodiments of the disclosure. The NDP announcement frame may be transmitted by a beamformer to a beamformee to indicate the type of NDP frame that may be sent after the NDP announcement frame. NDP announcement frame 300 may comprise a frame control, duration, receiver address (RA), transmitter address (TA), sounding dialog token, one or more STA information and frame check sequence (FCS) fields. An exemplary frame control field may be the Frame Control field 301. The Frame Control field 301 may comprise a protocol version, type, subtype, to wireless distribution system (DS), from wireless DS, more fragments, retry, power management, more data, protected frame, and/or order fields. For the sake of brevity the order of these fields is not illustrated in FIG. 3, however the contents of the fields are described herein. An exemplary duration field may be the Duration field 302. The Duration 302 field may be 16 bits in length and may comprise information about the frame type (e.g., VHT or HE NDP frame) and subtype, whether the frame is transmitted during a contention free period (CFP), and quality of service (QoS) capabilities of the transmitting station. An exemplary receiver address field may be the RA field 303. The RA field 303 may be the Media Access Control (MAC) address of a receiving device (e.g., SU beamformee). An exemplary duration field may be the TA field 304. The TA field may be the MAC address of the transmitting device (e.g., beamformer). An exemplary sounding dialog token field may be the Sounding Dialog Token field 305. The Sounding Dialog Token field 305 may comprise at least two subfields corresponding to the NDP type field (e.g., NDP Type field 310) and a real or natural number (e.g., Sounding Dialog Token Number field 320) associated with the sounding dialog token. The NDP Type field 310 may be two bits in length and comprise bits B0 311 and B1 312. If the bits B0 311 and B1 312 are both equal to 0, then the transmitted NDP may be a non-HE NDP. For example, the NDP may be a VHT NDP. If the bits B0 311 and B1 312 are equal to 0 and 1 respectively, then the transmitted NDP may be a HE NDP. If the bits B0 311 and B1 312 are equal to 1 and 0 or 1 and 1 respectively, then the NDP type may be neither VHT or HE. The bits B0 311 and B1 312 may be set equal 1 and 0 or 1 and 1 respectively for reserved NDP types. In some embodiments, these bits may be reserved for non NDP frames. The Sounding Dialog Token Number 320 may be a real or natural number represented by the B2 321 through B7 371 bits. Accordingly, the transmitting STA may assign up to 128 unique real or natural numbers to the Sounding Dialog Token Number 320. The Sounding Dialog Token 305 may comprise eight bits, or an octet of bits (e.g., the Sounding Dialog Token Octet). Exemplary station information fields may be the STA Info 1 306 . . . STA Info n 308 fields. Each of the station information fields may comprise subfields corresponding to the AID of each of the receiving STAs (beamformees), the feedback type (e.g., SU or MU) requested of each of the beamformees, and a number of columns permitted in a beamforming matrix requested from each of the beamformees. Exemplary frame check sequences (FCSs) may be the FCS 307 . . . FCS 309. The FCSs 307 . . . 309 may be thirty-two bits in length and may comprise a thirty-two bit cyclic redundancy check (CRC). The FCS may be calculated by the beamformee, upon receipt, over all of the fields of a MAC header of the frame carrying the NDP announcement frame 300. The FCSs may be calculated using, for example, a generator polynomial of degree thirty-two according to the expression G(x)=x³²+x²⁶+x²³+x²²+x¹⁶+x¹²+x¹¹+x¹⁰+x+x⁷+x⁵+x⁴+x²+x+1. The FCS is the 1s complement of the sum (modulo 2) of the following: the remainder of x^{k}×(x³¹+x³⁰+x⁹+ . . . +x²+x+1) divided (modulo 2) by G(x), where k is the number of bits in the calculation fields, and the remainder after multiplication of the contents (treated as a polynomial) of the calculation fields by x³² and then division by G(x). The FCS field is transmitted commencing with the coefficient of the highest-order term. At the transmitter, the initial remainder of the division is present to all Is and is then modified by division of the calculation fields by the generator polynomial G(x). The is complement of this remainder is transmitted, with the highest-order bit first, as the FCS field. At the receiver, the initial remainder is preset to all Is and the serial incoming bits of the calculation fields and FCS, when divided by G(x), results (in the absence of transmission errors) in a unique nonzero remainder value. The unique remainder value is the polynomial: x³¹+x³⁰+x²⁶+x²⁵+x²⁴+x¹⁸+x¹⁵+x¹⁴+x¹²+x¹¹+x¹⁰+x⁸+x⁶+x⁵+x⁴+x³+x+1. The Frame Control 301 may be two octets, Duration 302 may be two octets, RA 303 may be six octets, TA 304 may be six octets, Sounding Dialog Token may be one octet, each of STA Info 1 . . . STA Info n may be two octets, and each of FCS 307 . . . FCS 309 may be four octets.

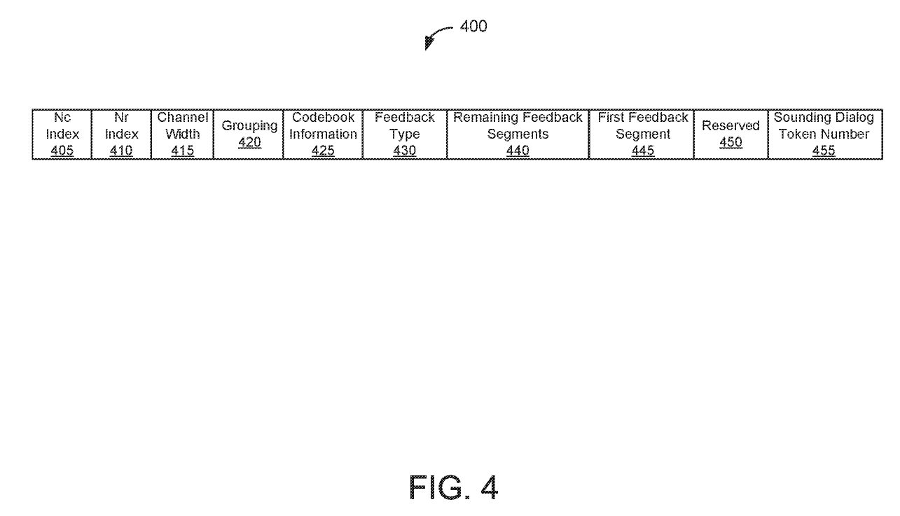

FIG. 4 is an illustrative frame format of a high-efficiency (HE) control field within a compressed beamforming feedback report (CBFR) sent by a beamformee, in accordance with example embodiments of the disclosure.

As shown in FIG. 4, in terms of the HE MIMO control field 400, a HE compressed feedback report can use the HE MIMO control field with a frame format similar to the VHT MIMO control field. For example, the Nc Index sub-field 405 and Nr Index sub-field 410 can be defined as in VHT MIMO control field. The channel width sub-field 415 can be defined similar to the VHT MIMO control field. The beamformee can indicate the partial or full bandwidth for feedback reporting. The grouping sub-field (2 bits) 420 can be set to “0” for Ng=2; the grouping sub-field can be set to “1” for Ng=4; the grouping sub-field 420 can be set to “2” for Ng=8; and the grouping sub-field 420 can be set to “3” for Ng=16. The codebook information field 425 for HE SU field can be defined similar to the VHT MIMO control field. The codebook information field 425 may be 1 bit in length and may be used by a processor in the beamformee to quantize one or more angles corresponding to one or more angles of arrival associated with the greatest received signal strength from the beamformer. The feedback type field 430 can be set to “0” for HE SU beamforming. The remaining feedback segment 440, first feedback segment 445, and sounding dialog token number sub-fields 455 can be defined similar to the VHT MIMO control field. The Sounding Dialog Token Number 455 may be the same as the Sounding Dialog Token Number 320.

In another embodiment, the rules for beamformer and beamformee in SU beamforming can be as follows. If the number of STA info field is equal to “1” and the value in resource allocation field (RA) is equal to the MAC address corresponding to an AID 12 field, then NDP-A can be designated for SU beamforming.

Moreover, for SU beamforming, the feedback type sub-field within the STA Info 1 field can be set to “0” (indicating a SU mode of operation). The Nc index field 405 can be reserved when the feedback type field is set to “0”. If the HE SU beamformee receives an NDP-A frame from the beamformer, it can wait for NDP frame reception in order to create the beamforming feedback report. The beamformee can send the feedback report frame to the beamformer in an SIFS.

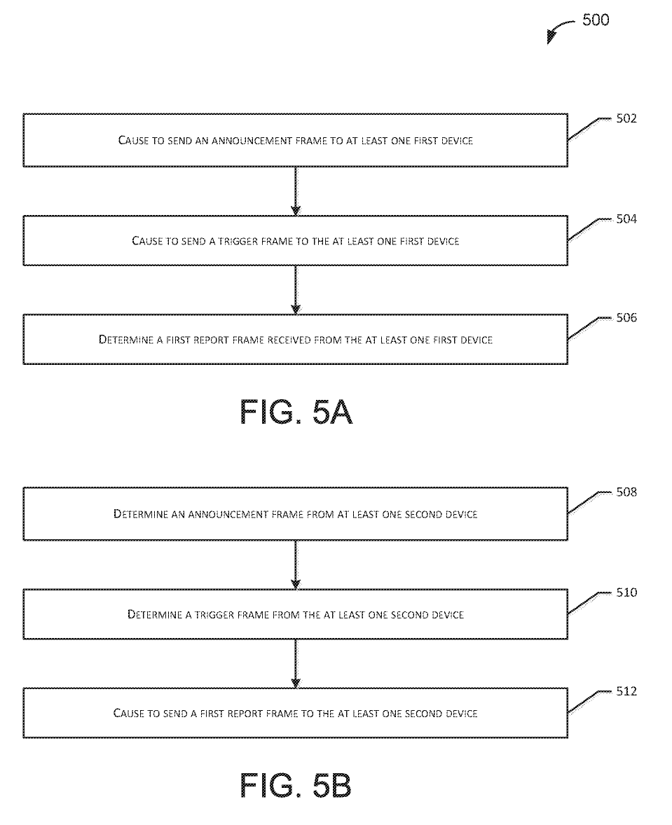

FIG. 5A is an illustrative flow diagram of a sounding protocol, in accordance with example embodiments of the disclosure. At block 502, a STA, or more appropriately at least one processor in the STA may store computer-executable instructions which when executed by a processor will cause the processor in the STA to send an announcement frame (e.g., NDP announcement frame) to at least one first device (e.g., beamformer). In some embodiments the STA may be an access point (AP) and may be referred to as the beamformer, and the first device may be another STA, for example a user device (e.g., mobile phone) and may be referred to as the beamformee. In some embodiments the NDP announcement frame may be a VHT NDP announcement frame, and in other embodiments it may be a HE NDP announcement frame. The NDP announcement frame type, may be indicated by NDP Type 310 thereby indicating whether the NDP frame that will be sent later is a VHT NDP frame or HE NDP frame.

At block 504 the processor may execute computer-executable instructions that cause the processor to send a trigger frame (e.g., NDP frame) to the at least one first device. The NDP frame may be a VHT NDP frame or a HE NDP frame. The processor may delay a SIFS period between block 502 and block 504.

At block 506, the processor may execute computer-executable instructions that cause the processor to determine a first report frame received from the at least one first device. The first report frame may be a compressed beamforming feedback report. The compressed beamforming feedback report may comprise HE MIMO control field 400 in FIG. 4. As an example, the compressed beamforming feedback reports may include information about a channel between the beamformer and the respective beamformee. For instance, the information about the channel may include information about the width of the channel. For instance, the width of the channel may be measured in hertz corresponding to the amount of bandwidth in frequency occupied by the width of a channel. The width of the channel may also be measured in bits also representing the bandwidth that may be supported by the channel. In some embodiments, wider channels may require larger beamforming matrices because there may be more subcarriers (e.g., subcarrier frequencies) that must be measured by the beamformee. Accordingly, if a first beamformee is using a first channel with a greater width than a second beamformee using a second channel, the first beamformee may have to measure more subcarriers each of which may correspond to a sub-band within the total bandwidth occupying the channel. As a result the first beamformee may generate a larger beamforming matrix than a beamforming matrix generated by the second beamformee.

The beamforming feedback reports may also include information about beamforming matrices corresponding to a number of spatial streams used to transmit and receive data between each of the beamformees and the beamformer. For example, the beamformee may transmit and/or receive data from the beamformer over eight spatial streams, and may determine beamforming matrices for each of one or more channels used to transmit and receive data with each of the eight spatial streams. In some instances the entries in the beamforming matrices, corresponding to a channel of two or more spatial streams may be the same, or approximately the same based on one or more statistical values (e.g., a p-value or calculated probability value), and therefore may be grouped together and a value may be included in a field of the beamforming feedback report indicating that two or more spatial streams have the same, or similar, beamforming matrices.

The beamforming matrices may be used by the beamformer to determine which antenna on the beamformer to transmit frames on to maximize throughput and minimize interference between the antenna on the beamformer and an antenna on a beamformee.

The beamformees may determine the beamforming matrices by processing each OFDM symbols received in a NDP frame. Each of the beamforming matrices may correspond to an OFDM symbol, and the beamforming matrix corresponding to the OFDM symbol may describe the performance of each subcarrier associated with the OFDM symbol between each transmitter antenna element and each receiver antenna element attached to the beamformer and a beamformee respectively. The entries in the matrix may comprise information about the received power levels and phase shifts between each transmitter antenna element and each receiver antenna element.

The beamforming matrices may be transformed by a matrix multiplication operation that may result in a Givens rotation of one or more entries in the beamforming matrices. The Givens rotation may be based on angles that may be determined by a beamformer or beamformee in order for the beamformer to determine the transmission power on a plurality of beamformer antenna. The transmission power on each of the plurality of beamformer antenna may be different, resulting in a signal that is directed to one or more antenna on the beamformee with the greatest received signal strength. The beamformee may calculate the angles based on the matrix rotation because of the Givens rotation is based on the angels. The beamforemee may transmit the angles in the beamforming matrix in a particular order, so that the beamformer can delimit each angle. After the beamformee calculates the angels, the beamformee may compress the entries in the beamforming matrix, and may return the compressed beamforming matrix in a compressed beamforming feedback report. The compressed beamforming matrix may summarize the radio link quality/performance for all of the OFDM subcarriers. Upon receipt of the compressed beamforming matrix, the beamformer may determine a steering matrix that may be used to steer data transmitted to the beamformee to the correct transmit antenna on the beamformer so that the radio link with the optimal quality/performance is used to transmit the data.

After block 502 the processor may end the process of FIG. 5A.

FIG. 5B is an illustrative flow diagram of a sounding protocol, in accordance with example embodiments of the disclosure. At block 508, a STA, or more appropriately at least one processor in the STA may store computer-executable instructions which when executed by a processor will cause the processor in the STA to determine an announcement frame (e.g., NDP announcement frame) from at least one second device (e.g., beamformee). In some embodiments the STA may be a user device and may be referred to as the beamformee, and the at least one second device may be an AP, for example a user device (e.g., mobile phone) and may be referred to as the beamformee. In some embodiments the NDP announcement frame may be a VHT NDP announcement frame, and in other embodiments it may be a HE NDP announcement frame. The NDP announcement frame type, may be indicated by NDP Type 310 thereby indicating whether the NDP frame that will be sent later is a VHT NDP frame or HE NDP frame.

At block 510 the processor may execute computer-executable instructions that cause the processor to determine a trigger frame (e.g., NDP frame) received from the at least one second device. The NDP frame may be a VHT NDP frame or a HE NDP frame. The processor may delay a SIFS period between block 502 and block 504.

At block 512, the processor may execute computer-executable instructions that cause the processor to send a first report frame received to the at least one second device. The first report frame may be a compressed beamforming feedback report. The compressed beamforming feedback report may comprise HE MIMO control field 400 in FIG. 4. As an example, the compressed beamforming feedback reports may include information about a channel between the beamformer and the respective beamformee. For instance, the information about the channel may include information about the width of the channel. For instance, the width of the channel may be measured in hertz corresponding to the amount of bandwidth in frequency occupied by the width of a channel. The width of the channel may also be measured in bits also representing the bandwidth that may be supported by the channel. In some embodiments, wider channels may require larger beamforming matrices because there may be more subcarriers (e.g., subcarrier frequencies) that must be measured by the beamformee. Accordingly, if a first beamformee is using a first channel with a greater width than a second beamformee using a second channel, the first beamformee may have to measure more subcarriers each of which may correspond to a sub-band within the total bandwidth occupying the channel. As a result the first beamformee may generate a larger beamforming matrix than a beamforming matrix generated by the second beamformee.

The beamforming feedback reports may also include information about beamforming matrices corresponding to a number of spatial streams used to transmit and receive data between each of the beamformees and the beamformer. For example, the beamformee may transmit and/or receive data from the beamformer over eight spatial streams, and may determine beamforming matrices for each of one or more channels used to transmit and receive data with each of the eight spatial streams. In some instances the entries in the beamforming matrices, corresponding to a channel of two or more spatial streams may be the same, or approximately the same based on one or more statistical values (e.g., a p-value or calculated probability value), and therefore may be grouped together and a value may be included in a field of the beamforming feedback report indicating that two or more spatial streams have the same, or similar, beamforming matrices.

The beamforming matrices may be used by the beamformer to determine which antenna on the beamformer to transmit frames on to maximize throughput and minimize interference between the antenna on the beamformer and an antenna on a beamformee.

The beamformees may determine the beamforming matrices by processing each OFDM symbols received in a NDP frame. Each of the beamforming matrices may correspond to an OFDM symbol, and the beamforming matrix corresponding to the OFDM symbol may describe the performance of each subcarrier associated with the OFDM symbol between each transmitter antenna element and each receiver antenna element attached to the beamformer and a beamformee respectively. The entries in the matrix may comprise information about the received power levels and phase shifts between each transmitter antenna element and each receiver antenna element.

The beamforming matrices may be transformed by a matrix multiplication operation that may result in a Givens rotation of one or more entries in the beamforming matrices. The Givens rotation may be based on angles that may be determined by a beamformer or beamformee in order for the beamformer to determine the transmission power on a plurality of beamformer antenna. The transmission power on each of the plurality of beamformer antenna may be different, resulting in a signal that is directed to one or more antenna on the beamformee with the greatest received signal strength. The beamformee may calculate the angles based on the matrix rotation because of the Givens rotation is based on the angels. The beamforemee may transmit the angles in the beamforming matrix in a particular order, so that the beamformer can delimit each angle. After the beamformee calculates the angels, the beamformee may compress the entries in the beamforming matrix, and may return the compressed beamforming matrix in a compressed beamforming feedback report. The compressed beamforming matrix may summarize the radio link quality/performance for all of the OFDM subcarriers. Upon receipt of the compressed beamforming matrix, the beamformer may determine a steering matrix that may be used to steer data transmitted to the beamformee to the correct transmit antenna on the beamformer so that the radio link with the optimal quality/performance is used to transmit the data.

After block 512 the processor may end the process of FIG. 5B.

It should be noted that even though the processes illustrated in FIGS. 5A and 5B are illustrated between a AP and user device, the process can, and may, take place between multiple user devices. In general a first user device may be a beamformee with respect to an AP, wherein the AP is a beamformer, and the first user device may be a beamformer with respect to a second user device, wherein the second user device is a beamformee with respect to the first device. Similarly a third device may be a beamformee with respect to second user device which may be a beamformer with respect to the third user device. Accordingly, each user device may be both a beamformee and beamformer with respect to another user device. In some embodiments, a first user device with a direct line of sight (e.g., without any obstacles impeding the flight path of a signal) between the first user device and an AP, may serve as the beamformer for one or more other user devices that do not have a line of sight to the AP. Accordingly, when the one or more other user devices determine their respective beamforming matrices, and transmit them to the first user device which may forward the beamforming matrices to the AP, the AP will better be able to determine the appropriate steering matrix to use to send and receive signals to and from the one or more other user devices because the first user device may have a line of sight with the one or more other user devices. This may be referred to as a mesh network, wherein each user device may send NDP announcement frames and NDP frames to another user device on behalf of the AP and may send compressed beamforming feedback reports from another user device to the AP on behalf of the other user device. Thus each user device may be a relay depending on the computational abilities of the user device. For example, a wearable device may not be a relay because the processor may not be able to provide the computational resources necessary to relay NDP announcement frames, NDP frames, and compressed beamforming feedback reports between an AP and other user devices (e.g., one of which may be a laptop computer). However the laptop computer may have a processor that does have the computational ability to relay this information between the AP and the other user devices. In some embodiments, the user devices that do have a processor that may relay information may compress one or more compressed beamforming feedback report matrices received from one or more user devices with limited processing capability respectively, before transmitting them to the AP. The mesh network scenario described above may be applied to an Internet of Things (IoT) connected network comprising one or more user devices (e.g., washing machine, drying machine, thermostat, computers, wearables, mobile phones, etc.) that may be within the house.

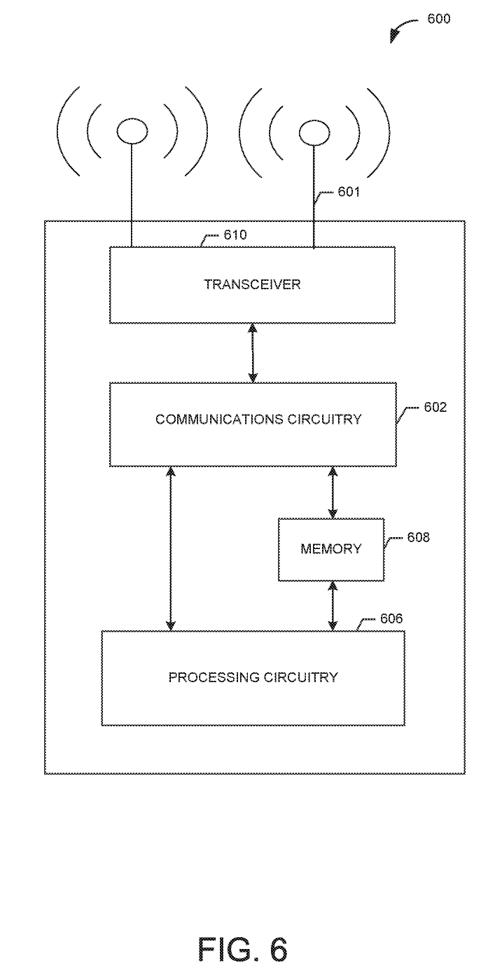

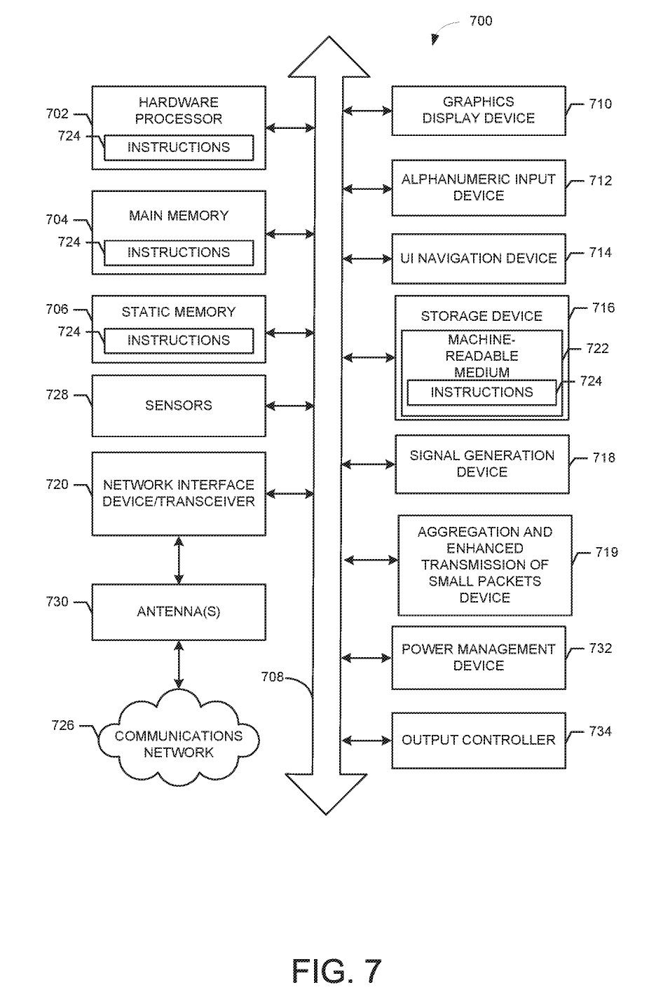

FIG. 6 shows a functional diagram of an exemplary communication station 600 in accordance with some embodiments. In one embodiment, FIG. 7 illustrates a functional block diagram of a communication station that may be suitable for use as an AP (e.g., the beamformer 107) or user STA (e.g., the beamformees 102) in accordance with some embodiments. The communication station 600 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer communications and/or medium access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 1-5.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device may, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 1000 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 1004 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a high efficiency signal field parallel coding device 719, a network interface device/transceiver 720 coupled to antenna(s) 730, and one or more sensors 728, such as a global positioning system (GPS) sensor, compass, accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The high efficiency signal field parallel coding device 719 may be configured to determine a communication channel between the device and a first device. The high efficiency signal field parallel coding device 719 may be configured to determine one or more subchannels of the communication channel. The high efficiency signal field parallel coding device 719 may be configured to determine a first high efficiency signal field and a second high efficiency signal field included in a high efficiency frame to be sent on the communication channel. The high efficiency signal field parallel coding device 719 may be configured to encode the second high efficiency signal field into one or more groups based at least in part on the one or more subchannels. It is understood that the above are only a subset of what the high efficiency signal field parallel coding device 719 may be configured to perform and that other functions included throughout this disclosure may also be performed by the high efficiency signal field parallel coding device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments can relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

In example embodiments of the disclosure, there may be a device, comprising: at least one memory that stores computer-executable instructions; and at least one processor of the one or more processors configured to access the at least one memory, wherein the at least one processor of the one or more processors is configured to execute the computer-executable instructions to: cause to send an announcement frame to at least one first device, wherein the announcement frame indicates the device capable of beamforming a single user (SU) device; cause to send a trigger frame to the at least one first device; determine a first report frame received from the at least one first device, wherein the report frame includes a first indication the at least one first device is a first SU device; and determine, based at least in part on the first report frame, to perform SU beamforming with the at least one first device.

Implementations may include the following features. The wherein the at least one processor of the one or more processors may be further configured to execute the computer-executable instructions to: cause to initiate SU beamforming with the first device. The at least one processor of the one or more processors may be further configured to execute the computer-executable instructions to: determine a second report frame from a second device, wherein the second report frame includes a second indication that the second device is a multiuser (MU) device. The announcement frame may be a NDP-A frame, the NDP-A frame may comprise a sounding dialog token, and the sounding dialog token may comprise a NDP type and sounding dialog token number. The first report frame may comprise a feedback type and the sounding dialog token. The NDP type may indicate a very high throughput (VHT) device or a high efficiency (HE) device. The device may further comprise a transceiver configured to transmit and receive wireless signals. The device may further comprise at least one antenna coupled to transceiver, wherein the at least one antenna is configured to dissipate and detect electromagnetic energy associated with transmitting and receiving the wireless signals respectively.

In some example embodiments of the disclosure, there may be a non-transitory computer-readable medium storing computer-executable instructions which, when executed by a processor, cause the processor to perform operations comprising: causing to send an announcement frame to at least one first device, wherein the announcement frame indicates the device capable of beamforming a single user (SU) device; causing to send a trigger frame to the at least one first device; determining a first report frame received from the at least one first device, wherein the report frame includes a first indication the at least one first device is a first SU device; and determining, based at least in part on the first report frame, to perform SU beamforming with the at least one first device.

Implementations may include the following features. The processor may execute further computer-executable instructions that cause the processor to perform operations comprising: causing to initiate SU beamforming with the first device. The processor may execute further computer-executable instructions that cause the processor to perform operations comprising: determining a second report frame from a second device, wherein the second report frame includes a second indication that the second device is a multiuser (MU) device. The announcement frame may be a NDP-A frame, the NDP-A frame may comprise a sounding dialog token, and the sounding dialog token may comprise a NDP type and sounding dialog token number. The first report frame may comprise a feedback type and the sounding dialog token. The NDP type may indicate a very high throughput (VHT) device or a high efficiency (HE) device.

In some example embodiments of the disclosure, there may be a device, comprising: at least one memory that stores computer-executable instructions; and at least one processor of the one or more processors configured to access the at least one memory, wherein the at least one processor of the one or more processors is configured to execute the computer-executable instructions to: determine an announcement frame from at least one second device; determine a trigger frame from the at least one second device; and cause to send a first report frame to the at least one second device.

Implementations may include the following features. The announcement frame may be a NDP-A frame, the NDP-A frame may comprise a sounding dialog token, and the sounding dialog token may comprise a NDP type and sounding dialog token number. The first report frame may comprise a feedback type and the sounding dialog token. The device may further comprise a transceiver configured to transmit and receive wireless signals. The device may further comprise at least one antenna coupled to transceiver, wherein the at least one antenna is configured to dissipate and detect electromagnetic energy associated with transmitting and receiving the wireless signals respectively.

In some example embodiments of the disclosure, there may be a non-transitory computer-readable medium storing computer-executable instructions which, when executed by a processor, cause the processor to perform operations comprising: determine an announcement frame from at least one second device; determine a trigger frame from the at least one second device; and cause to send a first report frame to the at least one second device.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation

What is claimed is:

1. A device, comprising:
at least one memory that stores computer-executable instructions; and
at least one processor of the one or more processors configured to access the at least one memory, wherein the at least one processor of the one or more processors is configured to execute the computer-executable instructions to:
cause to send an announcement frame to at least one first device, wherein the announcement frame indicates the device capable of beamforming a single user (SU) device;
cause to send a trigger frame to the at least one first device;
determine a first report frame received from the at least one first device, wherein the report frame includes a first indication the at least one first device is a first SU device; and
determine, based at least in part on the first report frame, to perform SU beamforming with the at least one first device.

2. The device of claim 1, wherein the at least one processor of the one or more processors is further configured to execute the computer-executable instructions to:
cause to initiate SU beamforming with the first device.

3. The device of claim 1, wherein the at least one processor of the one or more processors is further configured to execute the computer-executable instructions to:
determine a second report frame from a second device, wherein the second report frame includes a second indication that the second device is a multiuser (MU) device.

4. The device of claim 1, wherein the announcement frame is a NDP-A frame, the NDP-A frame comprises a sounding dialog token, and the sounding dialog token comprises a NDP type and sounding dialog token number.

5. The device of claim 4, wherein the first report frame comprises a feedback type and the sounding dialog token.

6. The device of claim 4, wherein the NDP type indicates a very high throughput (VHT) device or a high efficiency (HE) device.

7. The device of claim 1, further comprising a transceiver configured to transmit and receive wireless signals.

8. The device of claim 7, further comprising at least one antenna coupled to transceiver, wherein the at least one antenna is configured to dissipate and detect electromagnetic energy associated with transmitting and receiving the wireless signals respectively.

9. A non-transitory computer-readable medium storing computer-executable instructions which, when executed by a processor, cause the processor to perform operations comprising:
causing to send an announcement frame to at least one first device, wherein the announcement frame indicates the device capable of beamforming a single user (SU) device;
causing to send a trigger frame to the at least one first device;
determining a first report frame received from the at least one first device, wherein the report frame includes a first indication the at least one first device is a first SU device; and
determining, based at least in part on the first report frame, to perform SU beamforming with the at least one first device.

10. The non-transitory computer-readable medium of claim 9, wherein the processor executes further computer-executable instructions that cause the processor to perform operations comprising:
causing to initiate SU beamforming with the first device.

11. The non-transitory computer-readable medium of claim 9, wherein the processor executes further computer-executable instructions that cause the processor to perform operations comprising:
determining a second report frame from a second device, wherein the second report frame includes a second indication that the second device is a multiuser (MU) device.

12. The non-transitory computer-readable medium of claim 9, wherein the announcement frame is a NDP-A frame, the NDP-A frame comprises a sounding dialog token, and the sounding dialog token comprises a NDP type and sounding dialog token number.

13. The non-transitory computer-readable medium of claim 12, wherein the first report frame comprises a feedback type and the sounding dialog token.

14. The non-transitory computer-readable medium of claim 12, wherein the NDP type indicates a very high throughput (VHT) device or a high efficiency (HE) device.

15. A device, comprising:
at least one memory that stores computer-executable instructions; and
at least one processor of the one or more processors configured to access the at least one memory, wherein the at least one processor of the one or more processors is configured to execute the computer-executable instructions to:
determine an announcement frame from at least one second device;
determine a trigger frame from the at least one second device; and
cause to send a first report frame to the at least one second device.

16. The device of claim 15, wherein the announcement frame is a NDP-A frame, the NDP-A frame comprises a sounding dialog token, and the sounding dialog token comprises a NDP type and sounding dialog token number.

17. The device of claim 16, wherein the first report frame comprises a feedback type and the sounding dialog token.

18. The device of claim 15, further comprising a transceiver configured to transmit and receive wireless signals.

19. The device of claim 15, further comprising at least one antenna coupled to transceiver, wherein the at least one antenna is configured to dissipate and detect electromagnetic energy associated with transmitting and receiving the wireless signals respectively.

20. A non-transitory computer-readable medium storing computer-executable instructions which, when executed by a processor, cause the processor to perform operations comprising:
determine an announcement frame from at least one second device;
determine a trigger frame from the at least one second device; and
cause to send a first report frame to the at least one second device.
